(19) United States
(12) Patent Application Publication
(10) Pub. No.: US 2017/0195671 A1
(43) Pub. Date: Jul. 6, 2017

(54) METHOD AND APPARATUS FOR ENCODING VIDEO, AND METHOD AND APPARATUS FOR DECODING VIDEO

(71) Applicant: SAMSUNG ELECTRONICS CO., LTD., Gyeonggi-do (KR)

(72) Inventor: Byeong-doo CHOI, Suwon-si (KR)

(73) Assignee: SAMSUNG ELECTRONICS CO., LTD., Suwon-si (KR)

(21) Appl. No.: 15/320,559

(22) PCT Filed: Jun. 22, 2015
(86) PCT No.: PCT/KR2015/006325

§ 371 Date: Dec. 20, 2016

Related U.S. Application Data
(60) Provisional application No. 62/014,837, filed on Jun. 20, 2014.

(51) Int. Cl. H04N 19/119; H04N 19/60; H04N 19/122

(52) U.S. Cl. CPC H04N 19/119; H04N 19/122; H04N 19/60

(57) ABSTRACT

Provided are methods and apparatuses for encoding or decoding an image based on coding units that are hierarchically split and have various sizes and shapes. The video decoding method includes: splitting an encoded image into largest coding units; parsing, from a bitstream of the image, split information indicating whether to split a coding unit by two; parsing shape information indicating a split shape of a coding unit and including split direction information of a coding unit; and determining a coding unit hierarchically split from the largest coding unit by using the split information and the shape information.

### TECHNICAL FIELD

The present disclosure relates to video encoding and video decoding.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a quartered square block.

### DETAILED DESCRIPTION OF THE INVENTION

### Technical Problem

Provided are methods and apparatuses for encoding or decoding an image based on coding units that are hierarchically split and have various sizes and shapes.

### Technical Solution

A video decoding method according to an embodiment of the present disclosure includes: splitting an encoded image into largest coding units; parsing, from a bitstream of the image, split information indicating whether to split a coding unit by two; parsing shape information indicating a split shape of a coding unit and including split direction information of a coding unit; and determining a coding unit hierarchically split from the largest coding unit by using the split information and the shape information.

The shape information may include split direction information indicating that the coding unit is split in one of a vertical direction and a horizontal direction.

The largest coding unit may be hierarchically split into a coding unit having a depth including at least one of a current depth and a lower depth according to the split information, when direction information of the coding unit having the current depth indicates a vertical split, direction information of the coding unit having the lower depth indicates a horizontal split, and when the direction information of the coding unit having the current depth indicates a horizontal split, the direction information of the coding unit having the lower depth indicates a vertical split.

The shape information may include split position information indicating a split position corresponding to a position with respect to one of a height and a width of the coding unit.

The video decoding method may further include: determining a number by dividing one of the height and the width of the coding unit by a certain length; and determining a split position with respect to one of the height and the width of the coding unit, based on the number and the split position information.

The split position information may indicate that the coding unit is split by two at one of positions corresponding to ¼, ⅓, ⅔, and ¾ of one of the height and the width of the coding unit.

The video decoding method may further include determining at least one prediction unit split from the coding unit by using information about a partition type parsed from the bitstream.

The video decoding method may further include determining at least one transformation unit split from the coding unit by using information about a split shape of the transformation unit parsed from the bitstream.

The transformation unit may have a square shape, and a length of one side of the transformation unit may be a greatest common divisor of a length of a height of the coding unit and a length of a width of the coding unit.

The coding unit may be hierarchically split into a transformation unit having a depth including at least one of a current depth and a lower depth, based on information about a split shape of the transformation unit.

The video decoding method may further include: parsing encoding information indicating a presence or absence of a transformation coefficient for the coding unit; and when the encoding information indicates the presence of the transformation coefficient, parsing sub-encoding information indicating a presence or absence of transformation coefficients for each transformation unit included in the coding unit.

The largest coding units may have square shapes having a same size.

A video decoding apparatus according to an embodiment of the present disclosure includes: a receiver configured to parse, from a bitstream of an image, split information of a coding unit that indicates whether to split a coding unit by two, and parse shape information of the coding unit that indicates a split shape of the coding unit and including split direction information of the coding unit; and a decoder configured to split an encoded image into largest coding units and determine a coding unit hierarchically split from the largest coding units by using the split information and the shape information.

A program for performing the video decoding method according to an embodiment of the present disclosure may be recorded on a non-transitory computer-readable recording medium.

A video encoding method according to an embodiment of the present disclosure includes: splitting an image into largest coding units; hierarchically splitting coding units from the largest coding units; determining split information indicating whether to split the largest coding unit into two coding units and shape information indicating a split shape of the coding unit; encoding the split information and the shape information; and transmitting a bitstream including the encoded split information and the encoded shape information.

A video encoding apparatus according to an embodiment of the present disclosure includes: an encoder configured to split an image into largest coding units, hierarchically split a coding unit from the largest coding unit, determining split information indicating whether to split the largest coding unit into two coding units and shape information indicating a split shape of the coding unit, and encode the split information and the shape information; and a transmitter configured to transmit a bitstream including the encoded split information and the encoded shape information.

### DESCRIPTION OF THE DRAWINGS

FIG. 1 is a block diagram of a video decoding apparatus according to an embodiment of the present disclosure.

FIG. 2 is a flowchart of a video decoding method according to an embodiment of the present disclosure.

FIG. 3 is a block diagram of a video encoding apparatus according to an embodiment of the present disclosure.

FIG. 4 is a flowchart of a video encoding method according to an embodiment of the present disclosure.

FIG. 5 is a diagram illustrating splitting of a coding unit, according to an embodiment of the present disclosure.

FIG. 6 is a diagram illustrating hierarchical splitting of a coding unit, according to an embodiment of the present disclosure.

FIG. 7 is a flowchart of a process of splitting a coding unit, according to an embodiment of the present disclosure.

FIG. 8 is a diagram of a pseudo code that determines SplitNum, according to an embodiment of the present disclosure.

FIG. 9 is a diagram illustrating splitting of a coding unit, according to an embodiment of the present disclosure.

FIG. 10 is a diagram for describing a concept of coding units according to an embodiment of the present disclosure.

FIG. 11 is a block diagram of an image encoder based on coding units, according to an embodiment of the present disclosure.

FIG. 12 is a block diagram of an image decoder based on coding units, according to an embodiment of the present disclosure.

FIG. 13 is a diagram illustrating deeper coding units according to depths, and partitions, according to an embodiment of the present disclosure.

FIG. 14 is a diagram for describing a relationship between a coding unit and transformation units, according to an embodiment of the present disclosure.

FIG. 15 is a diagram for describing a plurality of pieces of encoding information according to depths, according to an embodiment of the present disclosure.

FIG. 16 is a diagram of deeper coding units according to depths, according to an embodiment of the present disclosure.

FIG. 17 is a diagram for describing a relationship between coding units, prediction units, and transformation units, according to an embodiment of the present disclosure.

FIG. 18 is a diagram for describing a relationship between coding units, prediction units, and transformation units, according to an embodiment of the present disclosure.

FIG. 19 is a diagram for describing a relationship between coding units, prediction units, and transformation units, according to an embodiment of the present disclosure.

FIG. 20 is a diagram for describing a relationship between a coding unit, a prediction unit, and a transformation unit, according to encoding mode information of Table 1.

### MODE OF THE INVENTION

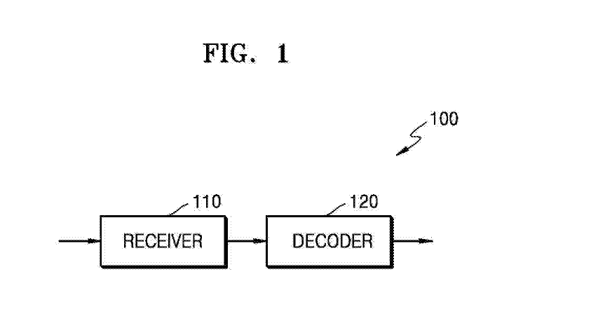

A video encoding apparatus, a video decoding apparatus, a video encoding method, and a video decoding method, according to embodiments of the present disclosure, will be described below with reference to FIGS. 1 through 9.

FIG. 1 is a block diagram of a video decoding apparatus according to an embodiment of the present disclosure.

The video decoding apparatus 100 according to an embodiment includes a receiver 110 and a decoder 120.

The receiver 110 may parse, from a bitstream of an image, coding unit split information indicating whether to split a coding unit by two. For example, the split information may have 1 bit. A case when the split information is “1” indicates that the coding unit is split by two, and a case when the split information is “0” indicates that the coding unit is not split by two. According to another embodiment of the present disclosure, the split information may have 1 bit or more. For example, when the split information has 2 bits, the video decoding apparatus 100 may determine whether to split the coding unit by two or four based on at least one of the 2 bits.

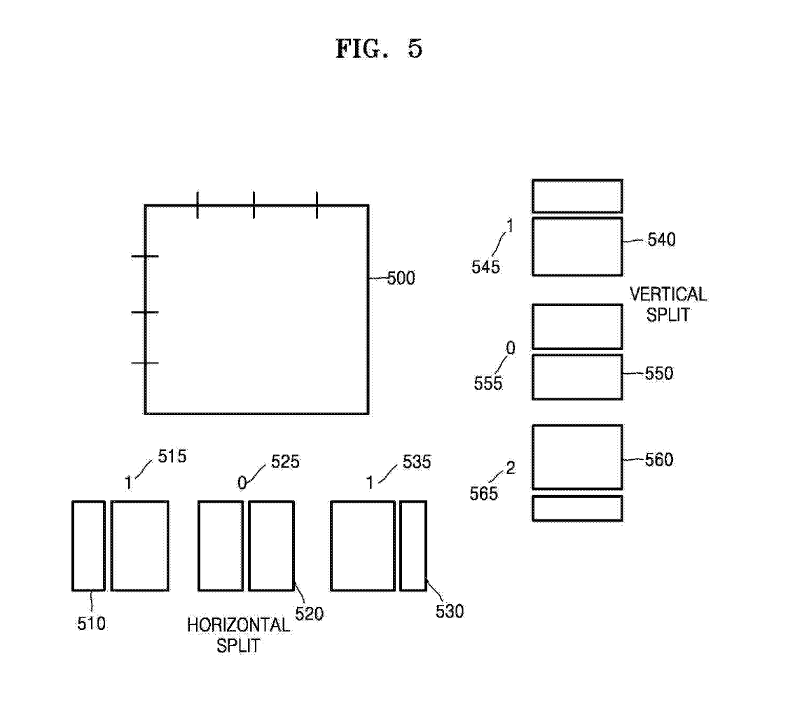

Also, the receiver 110 may parse coding unit shape information indicating a split shape of the coding unit and including split direction information of the coding unit. Split shape information will be described in detail with reference to FIG. 5.

Also, the decoder 120 may split an encoded image into largest coding units. The decoder 120 may split an image into the largest coding units by using “information about a minimum size of the coding unit” and “information about a difference value between a minimum size and a maximum size of the coding unit”.

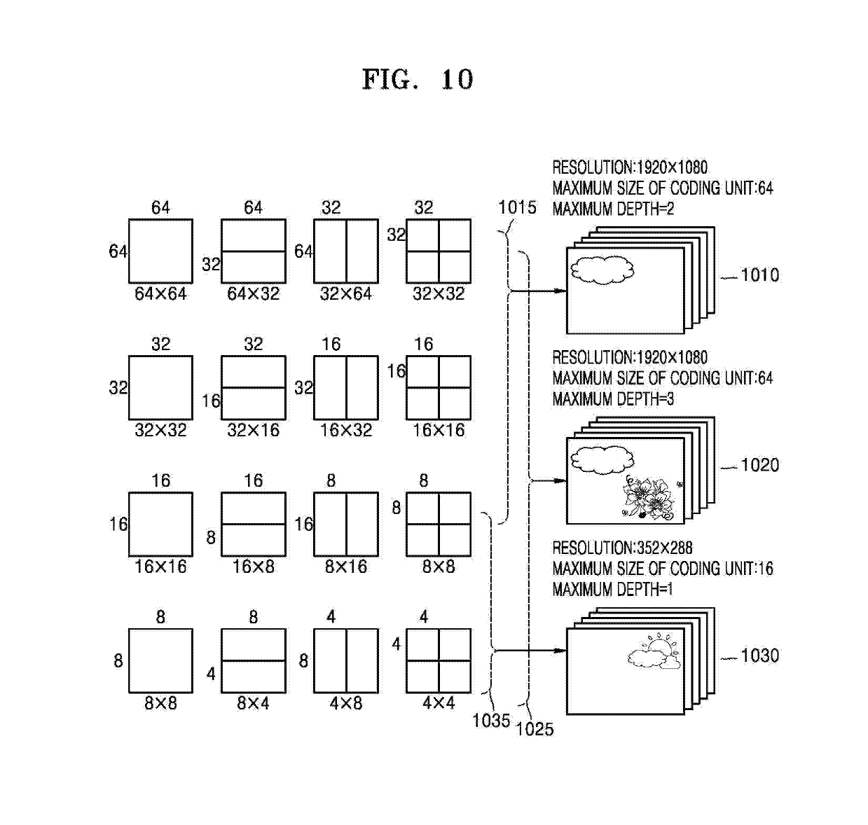

The largest coding units may have square shapes having the same size in order for compatibility with existing encoding and decoding methods and apparatuses. However, embodiments of the present disclosure are not limited thereto. The largest coding units may have square shapes having different sizes and may have rectangular shapes. The largest coding units will be described in more detail with reference to FIG. 10.

Also, the decoder 120 may determine at least one coding unit hierarchically split from a largest coding unit, among the largest coding units, by using the split information and the shape information. A size of a coding unit, among the at least one coding unit, may be equal to or smaller than a size of the largest coding unit. The coding unit may have a depth and a coding unit having a current depth may be hierarchically split into coding units having a lower depth. The video decoding apparatus 100 uses hierarchical coding units so as to consider characteristics of an image. If the video decoding apparatus 100 considers characteristics of an image, more efficient decoding may be achieved.

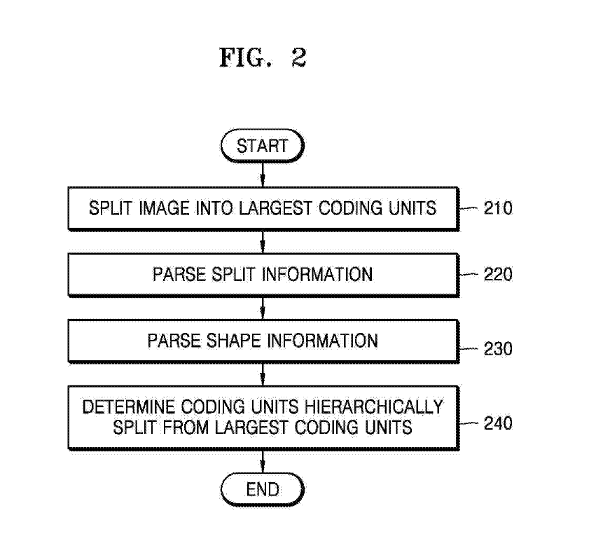

FIG. 2 is a flowchart of a video decoding method according to an embodiment of the present disclosure.

Hereinafter, the video decoding method according to the present disclosure will be described in more detail with reference to FIG. 2. Descriptions already provided above in the video decoding apparatus 100 of FIG. 1 are omitted.

Operation 210 may be performed by the decoder 120. Also, operations 220 and 230 may be performed by the receiver 110. Also, operation 240 may be performed by the decoder 120.

In operation 210, the video decoding apparatus 100 according to an embodiment of the present disclosure splits an image into largest coding units. In operation 220, the video decoding apparatus 100 according to an embodiment of the present disclosure may parse, from a bitstream, split information indicating whether to split a coding unit by two. Also, in operation 230, the video decoding apparatus 100 according to an embodiment of the present disclosure may parse shape information. The shape information indicates a split shape of the coding unit and includes split direction information of the coding unit. Split shape information will be described in detail with reference to FIG. 5.

Also, in operation 240, the video decoding apparatus 100 according to an embodiment of the present disclosure may determine coding units hierarchically split from the largest coding unit by using the split information and the shape information.

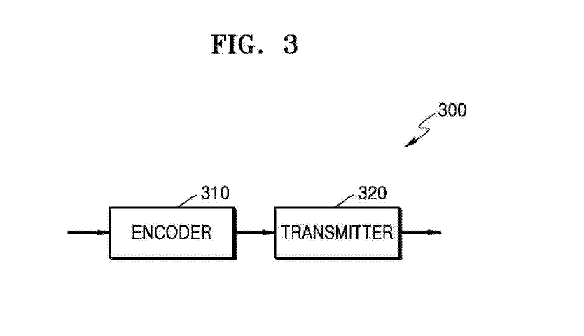

FIG. 3 is a block diagram of a video encoding apparatus according to an embodiment of the present disclosure.

The video encoding apparatus 300 according to an embodiment includes an encoder 310 and a transmitter 320.

The encoder 310 splits an image into largest coding units. The encoder 310 hierarchically splits coding units from largest coding unit. After splitting the largest coding unit into various coding units, the encoder 310 may find an optimal coding unit split structure by using rate-distortion optimization. The encoder 310 determines split information indicating whether to split the largest coding unit into two coding units and shape information indicating the split shape of the coding unit, based on the split structure. Also, the encoder 310 encodes the split information and the shape information. The split information has been described above with reference to FIG. 1 and the shape information will be described in detail with reference to FIG. 5.

The transmitter 320 may transmit a bitstream including encoded split information and encoded shape information. The receiver 110 of the video decoding apparatus 100 may receive the bitstream transmitted by the transmitter 320 of the video encoding apparatus 300.

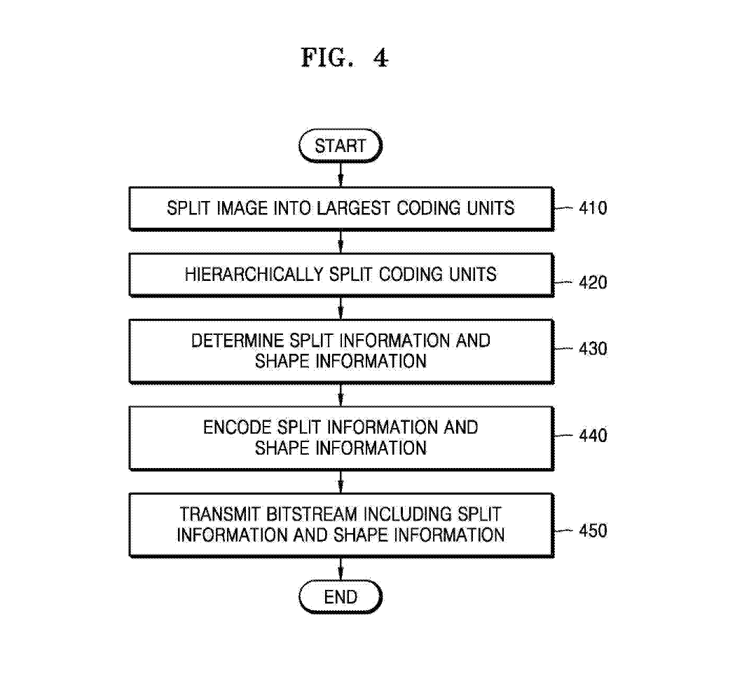

FIG. 4 is a flowchart of a video encoding method according to an embodiment of the present disclosure.

Hereinafter, the video encoding method according to the present disclosure will be described in more detail with reference to FIG. 4. Descriptions already provided above in the video encoding apparatus 300 of FIG. 3 are omitted.

Operations 410 to 440 may be performed by the encoder 310. Operation 450 may be performed by the transmitter 320.

In operation 410, the video encoding apparatus 300 according to an embodiment of the present disclosure splits an image into largest coding units. Also, in operation 420, the video encoding apparatus 300 according to an embodiment of the present disclosure hierarchically splits a coding unit from largest coding unit. Also, in operation 430, the video encoding apparatus 300 according to an embodiment of the present disclosure may determine split information indicating whether to split the largest coding unit into two coding units and shape information indicating the split shape of the coding unit. Also, in operation 440, the video encoding apparatus 300 according to an embodiment of the present disclosure may encode the split information and the shape information. Also, in operation 450, the video encoding apparatus 300 according to an embodiment of the present disclosure transmits a bitstream including the encoded split information and the encoded shape information.

FIG. 5 is a diagram illustrating splitting of a coding unit, according to an embodiment of the present disclosure.

Since descriptions of the encoding apparatus and method are similar to those of the decoding apparatus and method, the following descriptions will focus on the decoding apparatus and method.

The video decoding apparatus 100 may split an encoded image into largest coding units 500. The video decoding apparatus 100 may split the largest coding unit 500 into coding units. A size of the coding unit may be equal to or smaller than a size of the largest coding unit. The video decoding apparatus 100 may parse, from a bitstream, split information indicating whether to split the coding unit by two. When the split information indicates that the coding unit is split by two, the video decoding apparatus 100 may further parse the shape information from the bitstream. The shape information may indicate a split shape of the coding unit. Also, the shape information may indicate split direction information of the coding unit.

Also, the split direction information included in the shape information may indicate that the coding unit is split in one of a vertical direction and a horizontal direction. For example, split direction information of coding units 510, 520, and 530 may indicate that the coding units 510, 520, and 530 are split in a vertical direction. Also, split direction information of coding units 540, 550, and 560 may indicate that the coding units 540, 550, and 560 are split in a horizontal direction.

Also, according to an embodiment of the present disclosure, the video decoding apparatus 100 may hierarchically split a largest coding unit into coding units having a depth including at least one of a current depth and a lower depth based on the split information. Also, when the direction information of the coding unit having the current depth indicates a vertical split, the video decoding apparatus 100 may determine that the direction information of the coding unit having the lower depth is a horizontal direction. Accordingly, the video decoding apparatus 100 may not receive the direction information of the coding unit having the lower depth. Also, the video encoding apparatus 300 may not transmit the direction information of the coding unit.

Also, when the direction information of the coding unit having the current depth indicates a horizontal split, the video decoding apparatus 100 may determine that the direction information of the coding unit having the lower depth is a vertical direction. When the video decoding apparatus 100 alternately splits the coding unit in the vertical direction and the horizontal direction, the video decoding apparatus 100 has only to parse the direction information of the highest depth from the bitstream. Thus, a bit efficiency of the bitstream may be improved and a processing speed of the video decoding apparatus 100 may be increased.

Also, the shape information may include split position information indicating a split position corresponding to a certain position with respect to one of a height and a width of the coding unit. For example, as described above, the video decoding apparatus 100 may receive split direction information indicating that the coding units 510, 520, and 530 are vertically split. Also, the video decoding apparatus 100 may parse one of pieces of split position information 515, 525, 535, 545, 555, and 565 of the coding units 510, 520, 530, 540, 550, and 560. The video decoding apparatus 100 and the video encoding apparatus 300 may associate the split position information with a certain position of the coding unit.

When the split direction information of the coding units 510, 520, and 530 indicates a vertical split, the split position information 515, 525, and 535 may indicate a split position corresponding to a certain position with respect to a width of the coding unit.

For example, when the video decoding apparatus 100 receives the split position information 515 of “1”, the video decoding apparatus 100 may determine that a position corresponding to ¼ of the width of the coding unit 510 from a left side is a split position. Also, when the video decoding apparatus 100 receives the split position information 525 of “0”, the video decoding apparatus 100 may determine that a position corresponding to ½ of the width of the coding unit 520 from a left side is a split position. Also, when the video decoding apparatus 100 receives the split position information 515 of “2”, the video decoding apparatus 100 may determine that a position corresponding to ¾ of the width of the coding unit 530 from a left side is a split position.

Also, when the split direction information of the coding units 540, 550, and 560 indicates a horizontal split, the split position information 545, 555, and 565 may indicate a split position corresponding to a certain position with respect to a height of the coding unit. That is, the split position information 515, 525, and 535 may have the same value as the split position information 545, 555, and 565, but the meaning thereof may be changed according to the split direction information.

For example, when the video decoding apparatus 100 receives the split position information 545 of “1”, the video decoding apparatus 100 may determine that a position corresponding to ¼ of the height of the coding unit 540 from an upper side is a split position. Also, when the video decoding apparatus 100 receives the split position information 555 of “0”, the video decoding apparatus 100 may determine that a position corresponding to ½ of the height of the coding unit 550 from an upper side is a split position. Also, when the video decoding apparatus 100 receives the split position information 565 of “2”, the video decoding apparatus 100 may determine that a position corresponding to ¾ of the height of the coding unit 560 from an upper side is a split position.

A case when the split position information has 2 bits has been described above, but embodiments of the present disclosure are not limited thereto. 1 bit or more may be assigned thereto. For example, when the split position information has 3 bits, a total of eight split positions may be designated. For example, a position corresponding to 1/9 of the width of the encoding unit from a left side may be designated as a split position.

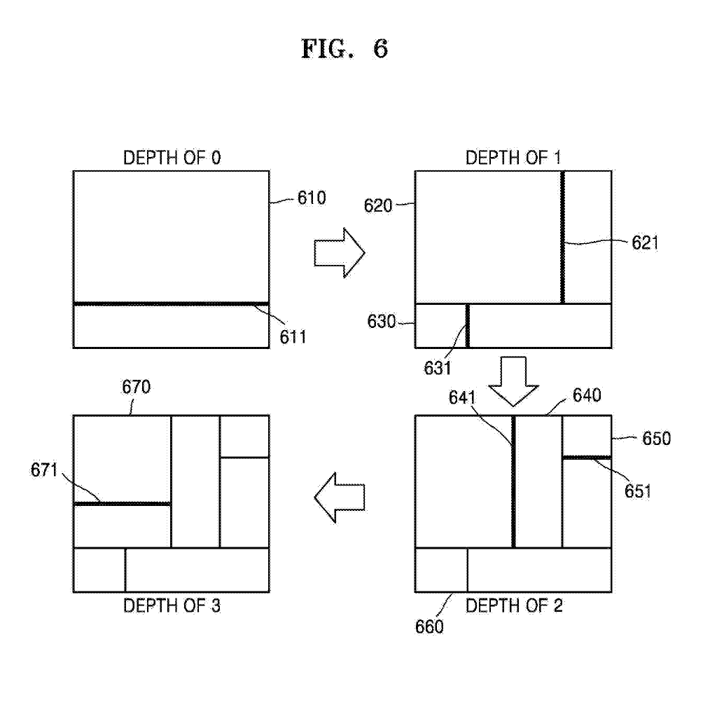

FIG. 6 is a diagram illustrating a hierarchical splitting of a coding unit, according to an embodiment of the present disclosure.

The video decoding apparatus 100 may parse, from a bitstream, split information about a coding unit 610 having a current depth. The current depth may be “depth of 0”. When the split information indicates the split of the coding unit, the video decoding apparatus 100 may parse shape information from the bitstream. The video decoding apparatus 100 may determine that the coding unit 610 is horizontally split, based on direction information included in the shape information.

The shape information may include split position information. The split position information may indicate that the coding unit is split at one of the positions corresponding to ¼, ⅓, ⅔, and ¾ of one of the height and the width of the coding unit. The video decoding apparatus 100 may determine that a position 611 corresponding to ¾ of the height of the coding unit 610 from an upper side is a split position, based on the split position information included in the shape information. For example, the coding unit 610 having a size of 32×32 may be split into two coding units having a size of 32×24 and 32×8.

The video decoding apparatus 100 may parse, from the bitstream, split information about coding units 620 and 630 having a lower depth. The lower depth may be “depth of 1”.

According to an embodiment of the present disclosure, when the split information indicates the split of the coding unit, the video decoding apparatus 100 may parse shape information from the bitstream. The video decoding apparatus 100 may determine that the coding units 620 and 630 are horizontally split, based on split direction information included in the shape information. Also, the video decoding apparatus 100 may determine that a position 621 corresponding to ¾ of the width of the coding unit 620 from a left side is a split position, based on the split position information included in the shape information. Also, the video decoding apparatus 100 may determine that a position 631 corresponding to ¼ of the width of the coding unit 620 from a left side is a split position. For example, the coding unit 620 having a size of 32×24 may be split into two coding units having a size of 24×24 and 8×24. Also, the coding unit 630 having a size of 32×8 may be split into two coding units having a size of 8×8 and 24×8.

According to another embodiment of the present disclosure, when the split information indicates the split of the coding unit, the video decoding apparatus 100 may determine split direction information of the lower depth (i.e., “depth of 1”) based on the current depth (i.e., “depth of 0”). For example, when the split direction information of the current depth indicates a horizontal direction, the video decoding apparatus 100 may determine that the split direction information of the lower depth is a vertical direction. On the contrary, when the split direction information of the current depth indicates a vertical direction, the video decoding apparatus 100 may determine that the split direction information of the lower depth is a horizontal direction.

The video decoding apparatus 100 may parse, from the bitstream, split information about coding units 640 and 650 having the lower depth. The lower depth may be “depth of 2”. When the split information indicates the split of the coding unit, the video decoding apparatus 100 may parse shape information from the bitstream. The video decoding apparatus 100 may determine that the coding unit 640 is vertically split, based on split direction information included in the shape information. Also, the video decoding apparatus 100 may determine that the coding unit 650 is horizontally split, based on split direction information included in the shape information. The video decoding apparatus 100 may determine that a position 641 corresponding to ⅔ of the width of the coding unit 640 from a left side is a split position, based on the split position information included in the shape information. Also, the video decoding apparatus 100 may determine that a position 651 corresponding to ⅓ of the height of the coding unit 650 from an upper side is a split position. Split information of the other lower coding units 660 may indicate that the coding unit is not split.

The video decoding apparatus 100 may parse, from the bitstream, split information about a coding unit 670 having a lower depth. The lower depth may be “depth of 3”. When the split information indicates the split of the coding unit, the video decoding apparatus 100 may parse shape information from the bitstream. The video decoding apparatus 100 may determine that the coding unit 670 is horizontally split, based on split direction information included in the shape information. Also, the video decoding apparatus 100 may determine that a position 671 corresponding to ⅔ of the height of the coding unit 670 from an upper side is a split position, based on the split position information included in the shape information.

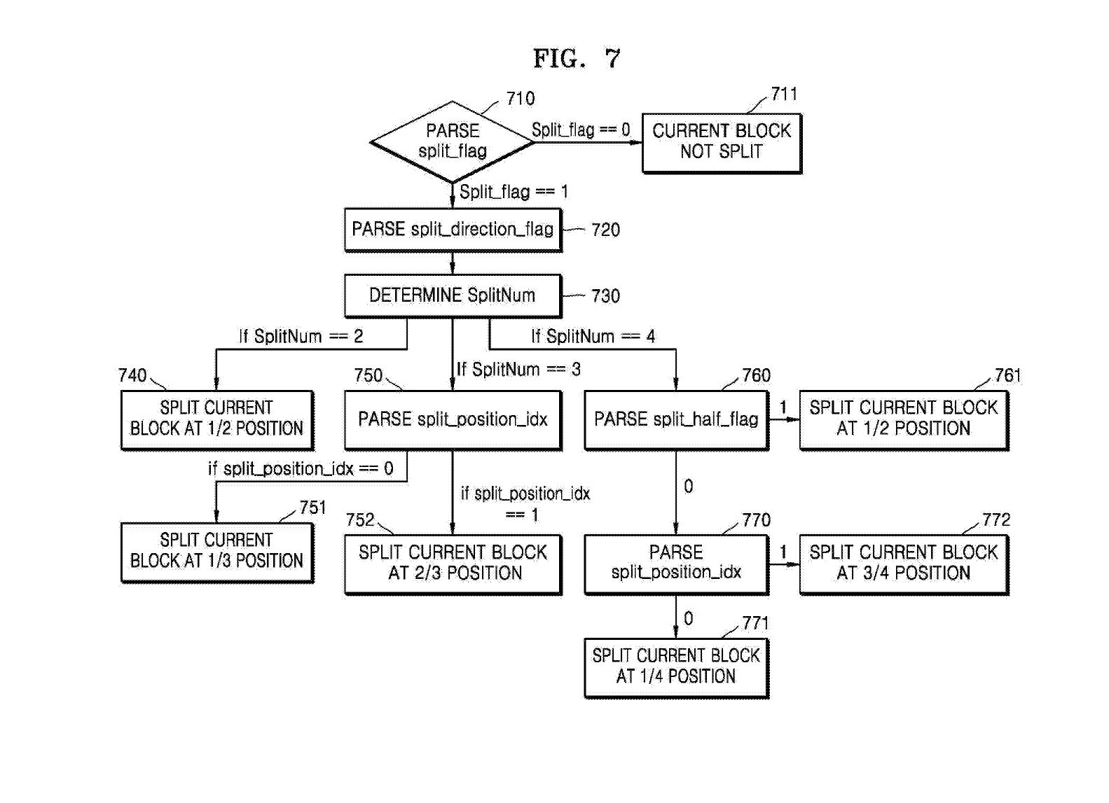

FIG. 7 is a flowchart of a process of splitting a coding unit, according to an embodiment of the present disclosure.

In operation 710, the video decoding apparatus 100 may parse split_flag from a bitstream. split_flag may mean split information. In operation 711, when split_flag is “0”, the video decoding apparatus 100 may not split a current block. The current block may be a coding unit having a current depth.

In operation 720, when split_flag is “1”, the video decoding apparatus 100 may parse shape information from a bitstream. The shape information may include split_direction_flag. split_direction_flag may indicate split direction information.

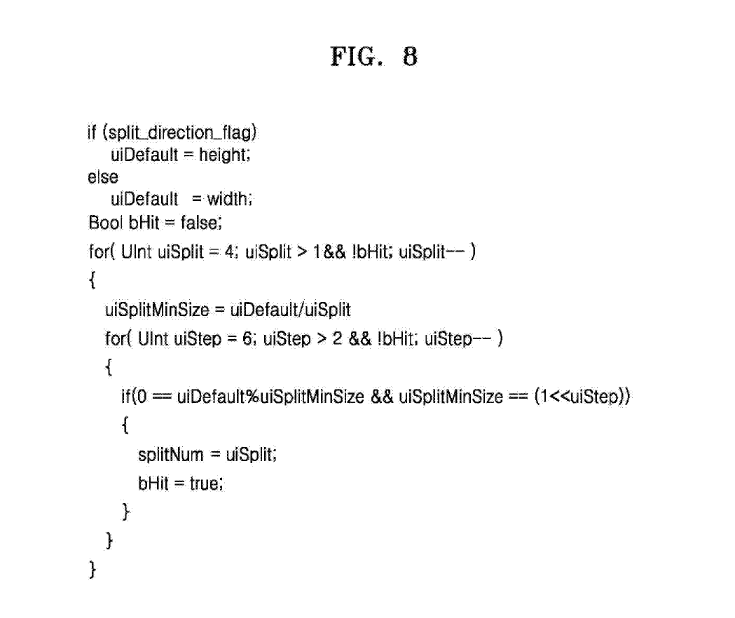

In operation 730, the video decoding apparatus 100 may determine SplitNum. SplitNum may mean a number obtained by dividing one of a height and a width of the coding unit by a certain length. The video decoding apparatus 100 may determine a split position with respect to one of the height and the width of the coding unit, based on the number SplitNum and split position information. The video decoding apparatus 100 may parse the certain length from the bitstream. Also, the video decoding apparatus 100 may not parse the certain length from the bitstream and may prestore the certain length in a memory. The certain length and the number SplitNum will be described in detail with reference to FIG. 8.

According to an embodiment of the present disclosure, in operation 740, when SplitNum is 2, the video decoding apparatus 100 may split one of the width and the height of the current block by two. In this case, the video decoding apparatus 100 may not separately parse the split position information from the bitstream.

Also, according to another embodiment of the present disclosure, in operation 750, when SplitNum is 3, the video decoding apparatus 100 may parse split_position_idx from the bitstream. split_position_idx may mean split position information. In operation 751, when split_position_idx is “0”, the video decoding apparatus 100 may select a position corresponding to ⅓ of the current block as a spilt position. For example, when split_direction_flag indicates a vertical direction, the video decoding apparatus 100 may split a position corresponding to ⅓ of the width of the current block from a left side.

Also, in operation 752, when split_position_idx is “1”, the video decoding apparatus 100 may select a position corresponding to ⅔ of the current block as a spilt position. For example, when split_direction_flag indicates a horizontal direction, the video decoding apparatus 100 may split a position corresponding to ⅔ of the height of the current block from an upper side.

Also, according to another embodiment of the present disclosure, in operation 760, when SplitNum is 4, the video decoding apparatus 100 may parse split_half_flag from the bitstream. split_half_flag may have 1 bit and may be included in the split position information. In operation 761, when split_half_flag is “1”, the video decoding apparatus 100 may split the current block by two.

Also, in operation 770, when split_half_flag is “0”, the video decoding apparatus 100 may parse split_position_idx from the bitstream. split_position_idx may have 1 bit and may be included in the split position information. In operation 771, when split_position_idx is “0”, the video decoding apparatus 100 may select a position corresponding to ¼ of the current block as a spilt position. For example, when split_direction_flag indicates a vertical direction, the video decoding apparatus 100 may split a position corresponding to ¼ of the width of the current block from a left side.

In operation 772, when split_position_idx is “1”, the video decoding apparatus 100 may select a position corresponding to ¾ of the current block as a spilt position. For example, when split_direction_flag indicates a horizontal direction, the video decoding apparatus 100 may split a position corresponding to ¾ of the width of the current block from an upper side.

The video decoding apparatus 100 has been described as separately parsing split_half_flag and split_position_idx in operations 760 and 770, but embodiments of the present disclosure are not limited thereto. For example, the video decoding apparatus 100 may parse, from the bitstream, 2-bit split position information including split_position_idx and split_half_flag at a time.

FIG. 8 is a diagram of a pseudo code that determines SplitNum, according to an embodiment of the present disclosure.

The video decoding apparatus 100 may parse split_direction_flag from a bitstream. split_direction_flag may mean split direction information. The video decoding apparatus 100 may determine uiDefault according to split_direction_flag.

For example, when split_direction_flag is “1”, the video decoding apparatus 100 may horizontally divide a coding unit. Also, when split_direction_flag is “1”, the video decoding apparatus 100 may determine uiDefault as a height of the coding unit. Also, when split_direction_flag is “0”, the video decoding apparatus 100 may vertically divide the coding unit. Also, when split_direction_flag is “0”, the video decoding apparatus 100 may determine uiDefault as a width of the coding unit.

bHit is a constant for escaping from an iterative statement when a specific condition is satisfied. The video decoding apparatus 100 resets bHit to “false”.

The video decoding apparatus 100 executes a “for” statement while decrementing uiSplit from 4 to 2 by 1. Also, unSplitMinSize is a certain length in operation 730 of FIG. 7 and is a value obtained by dividing the width or the height of the coding unit by uiSplit. However, the certain length is not limited thereto. The certain length in the pseudo code of FIG. 8 is calculated, but the video decoding apparatus 100 and the video encoding apparatus 300 may prestore the certain length. Also, the video encoding apparatus 300 may transmit the certain length to the video decoding apparatus 100.

The video decoding apparatus 100 executes a “for” statement while decrementing uiStep from 6 to 3 by 1. Also, when uiDefault is divided by uiSplitMinSize and uiSplitMinSize is equal to (1<<uiStep), the video decoding apparatus 100 sets splitNum to uiSplit. Also, the video decoding apparatus 100 sets bHit to “true” and escapes from the “for” statement.

According to another embodiment of the present disclosure, SplitNum is not calculated like the pseudo code of FIG. 8, and the video encoding apparatus 300 may transmit SplitNum to the video decoding apparatus 100. Also, the video decoding apparatus 100 and the video encoding apparatus 300 may prestore SplitNum.

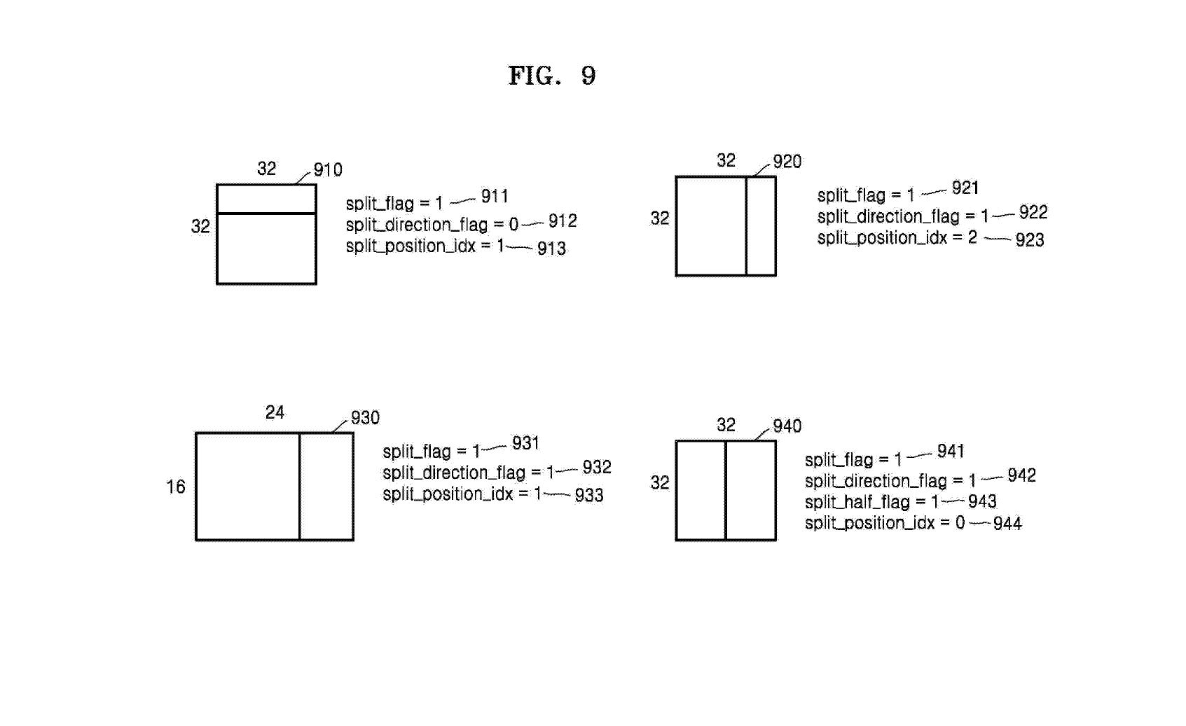

FIG. 9 is a diagram illustrating splitting of a coding unit, according to an embodiment of the present disclosure.

Referring to FIG. 9, a coding unit 910 may have a size of 32×32. The video decoding apparatus 100 may parse split_flag 911 from a bitstream. For example, when split_flag 911 is 1, the video decoding apparatus 100 may parse at least one of split_direction_flag 912 and split_position_idx 913 from the bitstream. When split_direction_flag 912 is 0, the video decoding apparatus 100 may horizontally split the coding unit 910 by two.

Also, the video decoding apparatus 100 may associate a value of split_position_idx 913 with a split position. For example, when the value of split_position_idx 913 is 0, the video decoding apparatus 100 may determine that a position corresponding to ½ of the height of the coding unit 910 from an upper side is a split position. Also, when the value of split_position_idx 913 is 1, the video decoding apparatus 100 may determine that a position corresponding to ¼ of the height of the coding unit 910 from the upper side is a split position. Also, when the value of split_position_idx 913 is 2, the video decoding apparatus 100 may determine that a position corresponding to ¾ of the height of the coding unit 910 from the upper side is a split position. In FIG. 9, since the value of split_position_idx 913 is 1, the video decoding apparatus 100 may split a position corresponding to ¼ of the height of the coding unit 910 from the upper side.

Referring to FIG. 9, a coding unit 920 may have a size of 32×32. The video decoding apparatus 100 may parse split_flag 921 from a bitstream. For example, when split_flag 921 is 1, the video decoding apparatus 100 may parse at least one of split_direction_flag 922 and split_position_idx 923 from the bitstream. When split_direction_flag 922 is 1, the video decoding apparatus 100 may vertically split the coding unit 920 by two. Also, when split_position_idx 923 is 2, the video decoding apparatus 100 may split a position corresponding to ¾ of the width of the coding unit 920 from a left side.

Referring to FIG. 9, a coding unit 930 may have a size of 24×16. The video decoding apparatus 100 may parse split_flag 931 from a bitstream. When split_flag 931 is 1, the video decoding apparatus 100 may parse at least one of split_direction_flag 932 and split_position_idx 933 from the bitstream. When split_direction_flag 932 is 1, the video decoding apparatus 100 may vertically split the coding unit 930 by two.

Also, when the value of split_position_idx 933 is 0, the video decoding apparatus 100 may determine that a position corresponding to ⅓ of the width of the coding unit 930 from the left side is a split position. Also, when the value of split_position_idx 933 is 1, the video decoding apparatus 100 may determine that a position corresponding to ⅔ of the width of the coding unit 930 from the left side is a split position. In FIG. 9, since the value of split_position_idx 933 is 1, the video decoding apparatus 100 may split a position corresponding to ⅔ of the width of the coding unit 930 from the left side.

Referring to FIG. 9, a coding unit 940 may have a size of 32×32. The video decoding apparatus 100 may parse split_flag 941 from a bitstream. When split_flag 941 is 1, the video decoding apparatus 100 may parse at least one of split_direction_flag 942, split_half_flag 943, and split_position_idx 944 from the bitstream. For example, when split_direction_flag 942 is 1, the video decoding apparatus 100 may vertically split the coding unit 940 by two. Also, when split_half_flag 943 is 1, the video decoding apparatus 100 may split the coding unit 940 by two. Also, the video decoding apparatus 100 may not receive split_position_idx 944. Also, the video encoding apparatus 300 may not transmit split_position_idx 944.

The video decoding apparatus 100 may determine at least one prediction unit split from the coding unit by using information about a partition type parsed from the bitstream. The video decoding apparatus 100 may hierarchically split the prediction unit in the same manner as in the coding unit described above. The coding unit may include a plurality of prediction units. A size of the prediction unit may be equal to or smaller than a size of the coding unit. The prediction unit may have a rectangular shape with various sizes. For example, the prediction unit may have a shape, such as 64×64, 64×32, 64×16, 64×8, 64×4, 32×32, 32×16, 32×8, or 32×4. Also, when the current coding unit is equal to a size of a smallest coding unit, the video decoding apparatus 100 may split the prediction unit from the coding unit.

FIG. 10 is a diagram for describing a concept of coding units according to an embodiment of the present disclosure.

A size of a coding unit may be expressed by width x height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4. Also, although not illustrated in FIG. 10, the coding unit may have a size of 32×24, 32×8, 8×24, 24×8, etc as described above with reference to FIGS. 5 through 9.

In video data 1010, a resolution is 1920×1080, a maximum size of a coding unit is 64, and a maximum depth is 2. In video data 1020, a resolution is 1920×1080, a maximum size of a coding unit is 64, and a maximum depth is 3. In video data 1030, a resolution is 352×288, a maximum size of a coding unit is 16, and a maximum depth is 1. The maximum depth shown in FIG. 10 denotes a total number of splits from a largest coding unit to a smallest coding unit.

If a resolution is high or a data amount is large, a maximum size of a coding unit may be large so as to not only increase encoding efficiency but also to accurately reflect characteristics of an image. Accordingly, the maximum size of the coding unit of the video data 1010 and 1020 having a higher resolution than the video data 1030 may be 64.

Since the maximum depth of the video data 1010 is 2, coding units 1015 of the video data 1010 may include a largest coding unit having a long axis size of 64, and coding units having long axis sizes of 32 and 16 since depths are deepened to two layers by splitting the largest coding unit twice. On the other hand, since the maximum depth of the video data 1030 is 1, coding units 1035 of the video data 1030 may include a largest coding unit having a long axis size of 16, and coding units having a long axis size of 8 since depths are deepened to one layer by splitting the largest coding unit once.

Since the maximum depth of the video data 1020 is 3, coding units 1025 of the video data 1020 may include a largest coding unit having a long axis size of 64, and coding units having long axis sizes of 32, 16, and 8 since the depths are deepened to three layers by splitting the largest coding unit three times. As a depth deepens, detailed information may be precisely expressed.

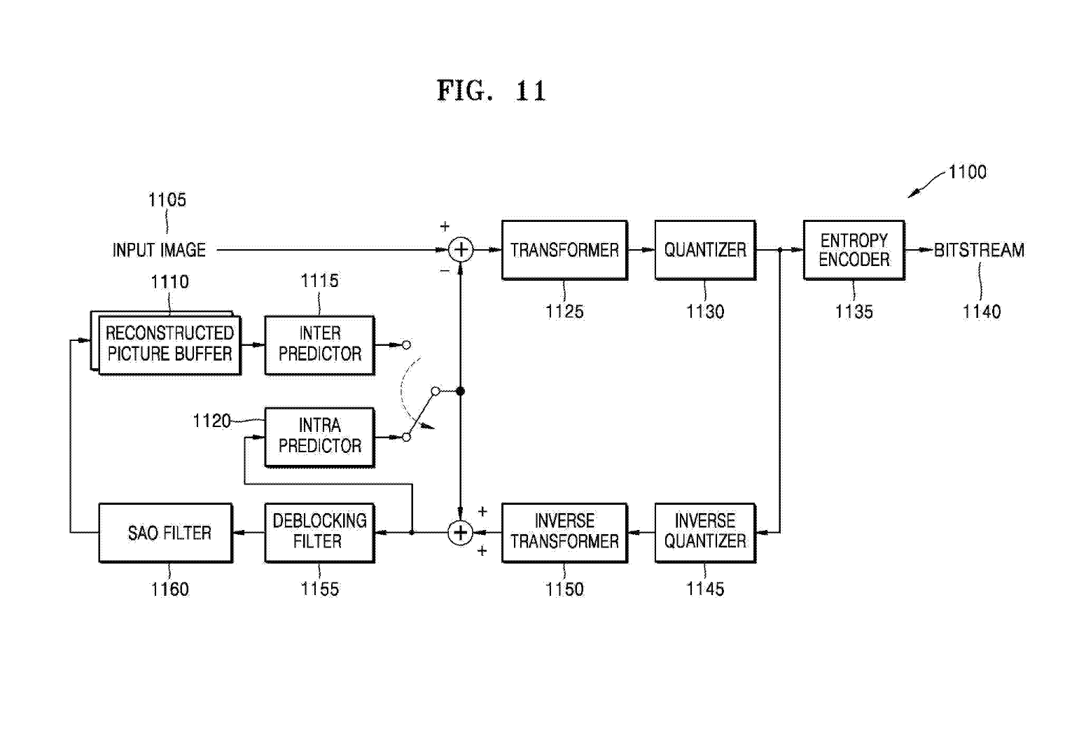

FIG. 11 is a block diagram of an image encoder 1100 based on coding units, according to an embodiment of the present disclosure.

The image encoder 1100 according to an embodiment performs operations of the encoder 310 of the video encoding apparatus 300 of FIG. 3 to encode image data. That is, an intra predictor 1120 performs intra prediction on coding units in an intra mode, from among a current image 1105, with respect to each prediction unit, and an inter predictor 1115 performs inter prediction on coding units in an inter mode by using the current image 1105 and a reference image obtained by a reconstructed picture buffer 1110 with respect to each prediction unit. The current image 1105 may be split into largest coding units and then sequentially encoded. In this case, encoding may be performed on coding units in which the largest coding unit are to be split into a tree structure.

Residue data is generated by subtracting prediction data output from the intra predictor 1120 or the inter predictor 1115 with respect to coding units in each mode from data for coding units of the current image 1105 to be encoded, and the residue data is output as a quantized transformation coefficient with respect to each transformation unit through a transformer 1125 and a quantizer 1130. The quantized transformation coefficient is reconstructed as residue data of a spatial domain through an inverse quantizer 1145 and an inverse transformer 1150. The reconstructed residue data of the spatial domain is added to the prediction data output from the intra predictor 1120 or the inter predictor 1115 with respect to coding units in each mode and is reconstructed as data of the spatial domain with respect to the coding units of the current image 1105. The reconstructed data of the spatial domain is generated as a reconstructed image through a deblocking filter 1155 and a sample adaptive offset (SAO) filter 1160. The generated reconstructed image is stored in the reconstructed picture buffer 1110. Reconstructed images stored in the reconstructed picture buffer 1110 may be used as a reference image for inter prediction of other images. The transformation coefficient quantized by the transformer 1125 and the quantizer 1130 may be output as a bitstream 1140 through an entropy encoder 1135.

In order for the image encoder 1100 according to an embodiment to be applied to the video encoding apparatus 300, the elements of the image encoder 1100, i.e., the inter predictor 1115, the intra predictor 1120, the transformer 1125, the quantizer 1130, the entropy encoder 1135, the inverse quantizer 1145, the inverse transformer 1150, the deblocking filter 1155, and the SAO filter 1160 may perform operations based on each coding unit among coding units having a tree structure with respect to each largest coding unit.

In particular, the intra predictor 1120 and the inter predictor 1115 may determine a partition mode and a prediction mode of each coding unit from among the coding units having a tree structure while considering the maximum size and the maximum depth of a current largest coding unit, and the transformer 1125 may determine whether to split the transformation unit having a quad tree in each coding unit from among the coding units having a tree structure.

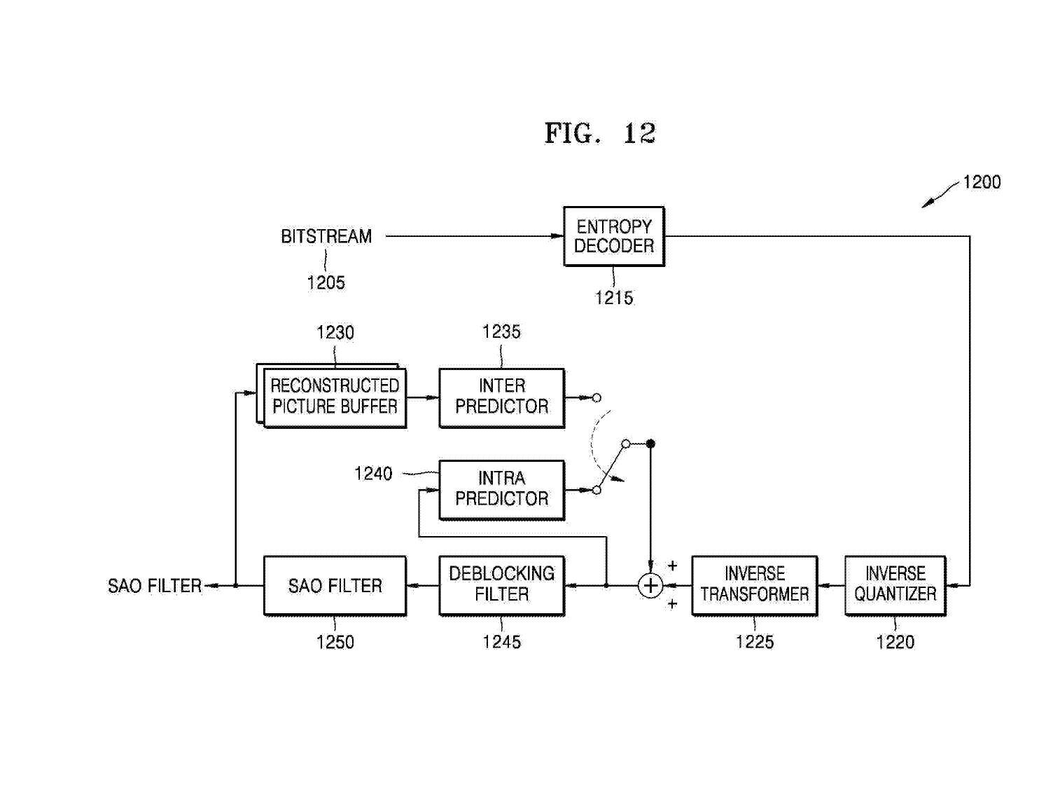

FIG. 12 is a block diagram of an image decoder 1200 based on coding units, according to an embodiment.

An entropy decoder 1215 parses, from a bitstream 1205, encoded image data to be decoded and information about encoding required for decoding. The encoded image data is a quantized transformation coefficient, and an inverse quantizer 1220 and an inverse transformer 1225 reconstruct residue data from the quantized transformation coefficient.

An intra predictor 1240 performs intra prediction on coding units in an intra mode with respect to each prediction unit. The inter predictor 1235 performs inter prediction on coding units in an inter mode, from among a current image, by using a reference image obtained by a reconstructed picture buffer 1230 with respect to each prediction unit

Data of the spatial domain with respect to coding units of the current image 1105 may be reconstructed by adding prediction data output from the intra predictor 1240 or the inter predictor 1235 with respect to coding units in each mode to residue data, and the reconstructed data of the spatial domain may be output as a reconstructed image 1260 through a deblocking filter 1245 and an SAO filter 1250. Also, reconstructed images stored in the reconstructed picture buffer 1230 may be output as a reference image.

In order to decode the image data in the decoder 120 of the video decoding apparatus 100, the decoder 120 may perform operations that are performed after the entropy decoder 1215 of the image decoder 1200 according to an embodiment.

In order for the image decoder 1200 to be applied to the video decoding apparatus 100 according to an embodiment, the elements of the image decoder 1200, i.e., the entropy decoder 1215, the inverse quantizer 1220, the inverse transformer 1225, the intra predictor 1240, the inter predictor 1235, the deblocking filter 1245, and the SAO filter 1250 may perform operations based on coding units having a tree structure with respect to each largest coding unit.

In particular, the intra predictor 1240 and the inter predictor 1235 may determine a partition mode and a prediction mode of each coding unit from among the coding units having a tree structure, and the inverse transformer 1225 may determine whether to split the transformation unit having a quad tree structure in each coding unit.

The image encoder 1100 of FIG. 11 and the image decoder 1200 of FIG. 12 may respectively encode and decode a video stream in a single layer. Therefore, if the video encoding apparatus 300 of FIG. 3 encodes video streams of two or more layers, the video encoding apparatus 300 may include the image encoder 1100 at each layer. Similarly, if the video decoding apparatus 100 of FIG. 1 decodes video streams of two or more layers, the video decoding apparatus 100 may include the image decoder 1200 at each layer.

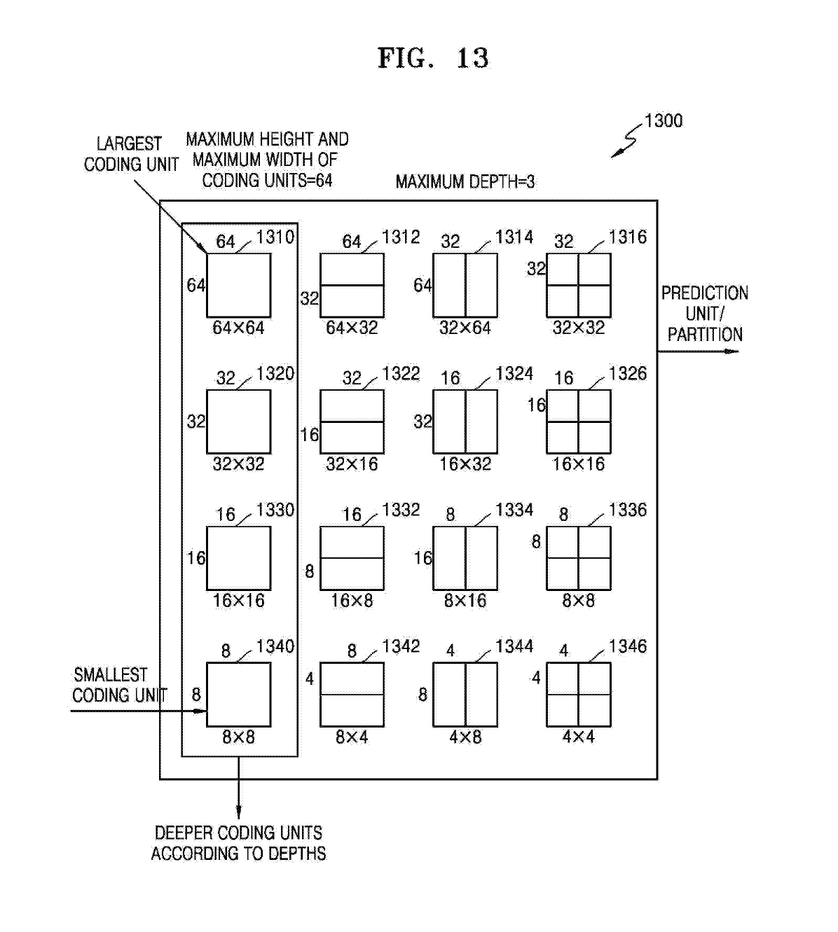

FIG. 13 is a diagram illustrating deeper coding units according to depths, and partitions, according to an embodiment of the present disclosure.

The video encoding apparatus 300 and the video decoding apparatus 100 according to an embodiment use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure 1300 of coding units according to an embodiment, the maximum height and the maximum width of the coding units are each 64, and the maximum depth is 3. In this case, the maximum depth refers to a total number of times the coding unit is split from the largest coding unit to the smallest coding unit. Since a depth deepens along a vertical axis of the hierarchical structure 1300 of the coding units according to an embodiment, a height and a width of the deeper coding unit are each split. Also, a prediction unit and partitions, which are bases for prediction encoding of each deeper coding unit, are shown along a horizontal axis of the hierarchical structure 1300 of the coding units.

That is, a coding unit 1310 is a largest coding unit in the hierarchical structure 1300 of the coding units, wherein a depth is 0 and a size, i.e., a height by width, is 64×64. The depth deepens along the vertical axis, and a coding unit 1320 having a size of 32×32 and a depth of 1, a coding unit 1330 having a size of 16×16 and a depth of 2, and a coding unit 1340 having a size of 8×8 and a depth of 3. The coding unit 1340 having the size of 8×8 and the depth of 3 is a smallest coding unit.

The prediction unit and the partitions of a coding unit are arranged along the horizontal axis according to each depth. That is, if the coding unit 1310 having the size of 64×64 and the depth of 0 is a prediction unit, the prediction unit may be split into partitions included in the coding unit 1310 having a size of 64×64, i.e. a partition 1310 having a size of 64×64, partitions 1312 having the size of 64×32, partitions 1314 having the size of 32×64, or partitions 1316 having the size of 32×32.

Equally, a prediction unit of the coding unit 1320 having the size of 32×32 and the depth of 1 may be split into partitions included in the coding unit 1320 having a size of 32×32, i.e. a partition 1320 having a size of 32×32, partitions 1322 having a size of 32×16, partitions 1324 having a size of 16×32, and partitions 1326 having a size of 16×16.

Equally, a prediction unit of the coding unit 1330 having the size of 16×16 and the depth of 2 may be split into partitions included in the coding unit 1330 having a size of 16×16, i.e. a partition 1330 having a size of 16×16, partitions 1332 having a size of 16×8, partitions 1334 having a size of 8×16, and partitions 1336 having a size of 8×8.

Equally, a prediction unit of the coding unit 1340 having the size of 8×8 and the depth of 3 may be split into partitions included in the coding unit 1340 having a size of 8×8, i.e. a partition 1340 having a size of 8×8, partitions 1342 having a size of 8×4, partitions 1344 having a size of 4×8, and partitions 1346 having a size of 4×4.

Although not illustrated in FIG. 13, the video decoding apparatus 100 may hierarchically split the prediction units from the coding units in the same manner as in the splitting of the coding units described above with reference to FIGS. 5 through 9.

In order to determine a depth of the largest coding unit 1310, the encoder 310 of the video encoding apparatus 300 according to an embodiment has to perform encoding on coding units respectively corresponding to depths included in the largest coding unit 1310.

A number of deeper coding units according to depths including data in the same range and the same size increases as the depth deepens. According to an embodiment of the present disclosure, four coding units corresponding to a depth of 2 may be required to cover data that is included in one coding unit corresponding to a depth of 1. Accordingly, in order to compare encoding results of the same data according to depths, the coding unit corresponding to the depth of 1 and four coding units corresponding to the depth of 2 may be each encoded.

According to another embodiment of the present disclosure, two coding units having a depth of 2 may be required for data included in one coding unit having a depth of 1. Accordingly, in order to compare encoding results of the same data according to depths, one coding unit having a depth of 1 and two coding units having a depth of 2 may be each encoded

In order to perform encoding for a current depth from among the depths, a representative encoding error that is a minimum encoding error may be selected for the current depth by performing encoding on each prediction unit in the coding units corresponding to the current depth, along the horizontal axis of the hierarchical structure 1300 of the coding units. Alternatively, the minimum encoding error may be searched for by comparing representative encoding errors according to depths, by performing encoding for each depth as the depth deepens along the vertical axis of the hierarchical structure 1300 of the coding units. A depth and a partition having the minimum encoding error in the largest coding unit 1310 may be selected as the depth and a partition mode of the largest coding unit 1310.

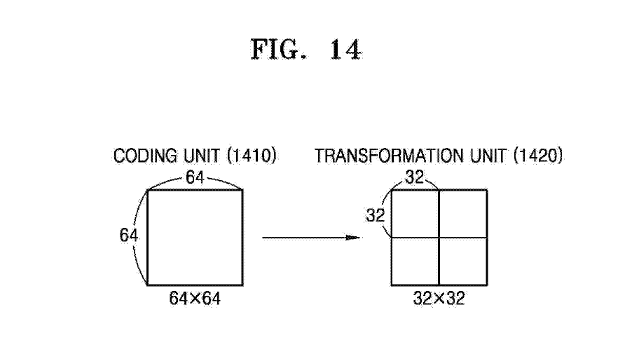

FIG. 14 is a diagram for describing a relationship between a coding unit and transformation units, according to an embodiment of the present disclosure.

The video encoding apparatus 300 according to an embodiment or the video decoding apparatus 100 according to an embodiment encodes or decodes an image according to coding units having sizes smaller than or equal to a largest coding unit for each largest coding unit. Sizes of transformation units for transformation during encoding may be selected based on data units that are not larger than a corresponding coding unit.

For example, in the video encoding apparatus 300 according to an embodiment or the video decoding apparatus 100 according to an embodiment, if a size of the coding unit 1410 is 64×64, transformation may be performed by using the transformation units 1420 having a size of 32×32.

Also, data of the coding unit 1410 having the size of 64×64 may be encoded by performing the transformation on each of the transformation units having the size of 32×32, 16×16, 8×8, and 4×4, which are smaller than 64×64, and then a transformation unit having the minimum coding error may be selected.

The video decoding apparatus 100 may determine at least one transformation unit split from the coding unit by using information about a split shape of the transformation unit parsed from the bitstream. The video decoding apparatus 100 may hierarchically split the transformation unit in the same manner as in the coding unit described above. The coding unit may include a plurality of transformation units.

The transformation unit may have a square shape. A length of one side of the transformation unit may be the greatest common divisor of a length of a height of the coding unit and a length of a width of the coding unit. For example, when the coding unit has a size of 24×16, the greatest common divisor of 24 and 16 is 8. Accordingly, the transformation unit may have a square shape with a size of 8×8. Also, six transformation units having a size of 8×8 may be included in the coding unit having a size of 24×16. In the related art, a transformation unit having a square shape is used. Thus, when the transformation unit has a square shape, additional basis may not be required.

However, embodiments of the present disclosure are not limited thereto. The video decoding apparatus 100 may determine the transformation unit included in the coding unit as any rectangular shape. In this case, the video decoding apparatus 100 may have a basis corresponding to the rectangular shape.

Also, the video decoding apparatus 100 may hierarchically split a transformation unit having a depth including at least one of a current depth and a lower depth from the coding unit, based on information about the split shape of the transformation unit. For example, when the coding unit has a size of 24×16, the video decoding apparatus 100 may divide the coding unit into six transformation units having a size of 8×8. Also, the video decoding apparatus 100 may split at least one of the six transformation units into transformation units having a size of 4×4.

Also, the video decoding apparatus 100 may parse, from the bitstream, encoding information indicating the presence or absence of transformation coefficients for the coding units. Also, when the encoding information indicates the presence of the transformation coefficients, the video decoding apparatus 100 may parse, from the bitstream, sub-encoding information indicating the presence or absence of transformation coefficients for each transformation unit included in the coding unit.

For example, when the encoding information indicates the absence of the transformation coefficient for the coding unit, the video decoding apparatus 100 may not parse the sub-encoding information. Also, when the encoding information indicates the presence of the transformation coefficient for the coding unit, the video decoding apparatus 100 may parse the sub-encoding information.

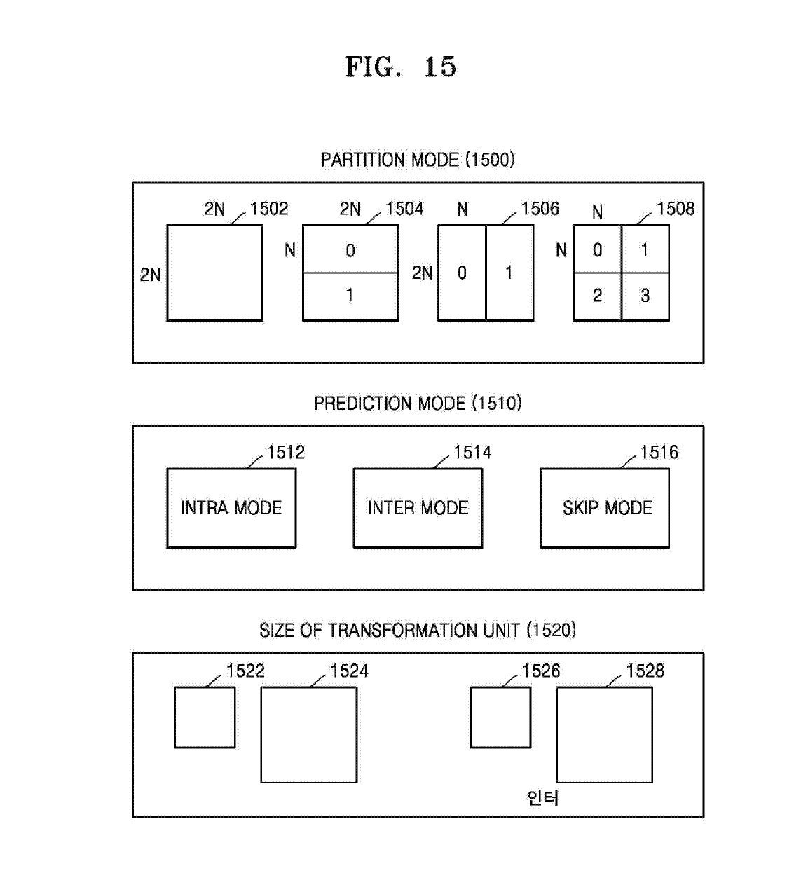

FIG. 15 is a diagram for describing a plurality of pieces of encoding information, according to an embodiment of the present disclosure.

The transmitter 320 of the video encoding apparatus 300 according to an embodiment may encode and transmit partition mode information 1500, prediction mode information 1510, and a transformation unit size information 1520 for each coding unit corresponding to a depth, as split information.

The partition mode information 1500 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 1502 having a size of 2N×2N, a partition 1504 having a size of 2N×N, a partition 1506 having a size of N×2N, and a partition 1508 having a size of N×N. Here, the partition mode information 1500 regarding the current coding unit is set to indicate one of the partition 1502 having a size of 2N×2N, the partition 1504 having a size of 2N×N, the partition 1506 having a size of N×2N, and the partition 1508 having a size of N×N.

However, the partition type is not limited thereto. The partition type may include asymmetrical partitions, partitions having any shape, and partitions having a geometrical shape. For example, a current coding unit CU_0 having a size of 4N×4N may be split into any one of a partition having a size of 4N×4N, a partition having a size of 4N×2N, a partition having a size of 4N×3N, a partition having a size of 4N×4N, a partition having a size of 3N×4N, a partition having a size of 2N×4N, a partition having a size of 1N×4N, and a partition having a size of 2N×2N. Also, a current coding unit CU_0 having a size of 3N×3N may be split into any one of a partition having a size of 3N×1N, a partition having a size of 3N×2N, a partition having a size of 3N×3N, a partition having a size of 2N×3N, a partition having a size of 1N×3N, and a partition having a size of 2N×2N. Also, a case when the current coding unit has a square shape has been described above, but the current coding unit may have any rectangular shape as described above with reference to FIGS. 5 through 9. The video decoding apparatus 100 may split a prediction unit having a current depth into prediction units having a lower depth by the coding unit splitting method described above with reference to FIGS. 5 through 9.

The prediction mode information 1510 indicates a prediction mode of each partition. For example, the prediction mode information 1510 may indicate a mode of prediction encoding performed on a partition indicated by the partition mode information 1500, i.e., an intra mode 1512, an inter mode 1514, or a skip mode 1516.

The transformation unit size information 1520 indicates a transformation unit to be based on when transformation is performed on a current coding unit. For example, the transformation unit may be a first intra transformation unit 1522, a second intra transformation unit 1524, a first inter transformation unit 1526, or a second inter transformation unit 1528.

The receiver 110 of the video decoding apparatus 100 according to an embodiment may extract and use the partition mode information 1500, the prediction mode information 1510, and the transformation unit size information 1520 for decoding, according to each deeper coding unit.

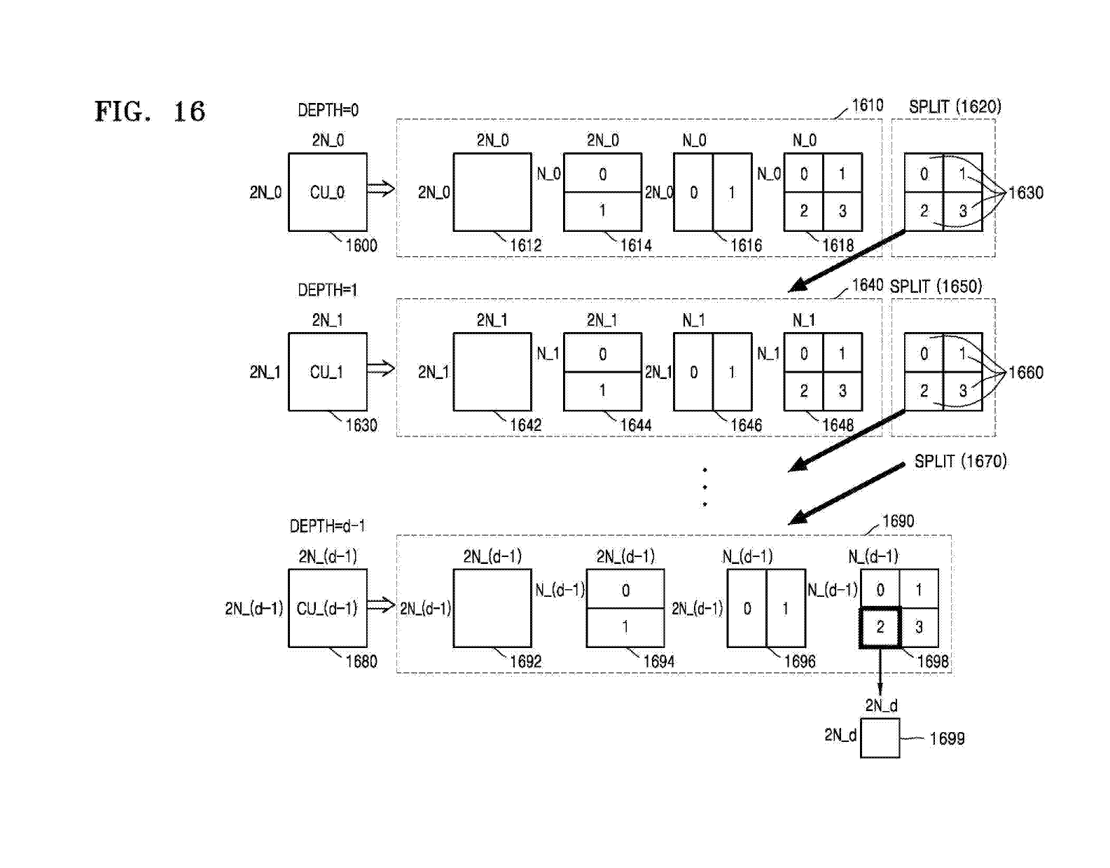

FIG. 16 is a diagram of deeper coding units according to depths, according to an embodiment of the present disclosure.

Split information may be used to indicate a change of a depth. The spilt information indicates whether a coding unit of a current depth is split into coding units of a lower depth.

A prediction unit 1610 for prediction encoding a coding unit 1600 having a depth of 0 and a size of 2N_0×2N_0 may include partitions of a partition mode 1612 having a size of 2N_0×2N_0, a partition mode 1614 having a size of 2N_0×N_0, a partition mode 1616 having a size of N_0×2N_0, and a partition mode 1618 having a size of N_0×N_0. FIG. 16 only illustrates the partition modes 1612, 1614, 1616, and 1618 which are obtained by symmetrically splitting the prediction unit 1610, but a partition mode is not limited thereto, and the partitions of the prediction unit 1610 may include asymmetrical partitions, partitions having an arbitrary shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_N_0×2N_0, 2N_0×N_0, and N_0×N_0. The prediction encoding in a skip mode may be performed only on the partition having the size of 2N_0×2N_0.

If an encoding error is smallest in one of the partition modes 1612, 1614, and 1616 having the sizes 2N_0×2N_0, 2N_0×N_0 and N_0×2N_0, the prediction unit 1610 may not be split into a lower depth.

If the encoding error is the smallest in the partition mode 1618 having the size of N_0×N_0, a depth is changed from 0 to 1 to split the partition mode 1618 in operation 1620, and encoding is repeatedly performed on coding units 1630 having a depth of 2 and a size of N_0×N_0 to search for a minimum encoding error.

A prediction unit 1640 for prediction encoding the coding unit 1630 having a depth of 1 and a size of 2N_1×2N_1 (=N_0×N_0) may include partitions of a partition mode 1642 having a size of 2N_1×2N_1, a partition mode 1644 having a size of 2N_1×N_1, a partition mode 1646 having a size of N_1×2N_1, and a partition mode 1648 having a size of N_1×N_1.

If an encoding error is the smallest in the partition mode 1648, a depth is changed from 1 to 2 to split the partition mode 1648 in operation 1650, and encoding is repeatedly performed on coding units 1660, which have a depth of 2 and a size of N_2×N_2 to search for a minimum encoding error.

When a maximum depth is d, deeper coding units according to depths may be set until when a depth corresponds to d−1, and split information may be set until when a depth corresponds to d−2. That is, when encoding is performed up to when the depth is d−1 after a coding unit corresponding to a depth of d−2 is split in operation 1670, a prediction unit 1690 for prediction encoding a coding unit 1680 having a depth of d−1 and a size of 2N_(d−1)×2N_(d−1) may include partitions of a partition mode 1692 having a size of 2N_(d−1)×2N_(d−1), a partition mode 1694 having a size of 2N_(d−1)×N_(d−1), a partition mode 1696 having a size of N_(d−1)×2N_(d−1), and a partition mode 1698 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes so as to search for a partition mode having a minimum encoding error.

Even when the partition mode 1698 having the size of N_(d−1)×N_(d−1) has the minimum encoding error, since a maximum depth is d, a coding unit CU_(d−1) having a depth of d−1 is no longer split to a lower depth, and a depth for the coding units constituting a current largest coding unit 1600 is determined to be d−1 and a partition mode may be determined to be N_(d−1)×N_(d−1). Also, since the maximum depth is d, split information for a coding unit 1652 having a depth of d−1 is not set.

A data unit 1699 may be a ‘minimum unit’ for the current largest coding unit. A minimum unit according to an embodiment may be a square data unit obtained by splitting a smallest coding unit having a lowermost depth by 4. By performing the encoding repeatedly, the video encoding apparatus 300 according to an embodiment may select a size of a coding unit having the minimum encoding error by comparing encoding errors according to depths of the coding unit 1600 to determine a depth of the coding unit, and may set a corresponding partition mode and a prediction mode as an encoding mode.

As such, the minimum encoding errors according to depths are compared in all of the depths of 0, 1, . . . , d−1, d, and a depth having the minimum encoding error may be selected. The depth, the partition mode of the prediction unit, and the prediction mode may be encoded and transmitted as the split information. Also, since a coding unit has to be split from a depth of 0 to the selected depth, only split information of the selected depth is set to 0, and split information of depths excluding the selected depth is set to 1.

The video decoding apparatus 100 according to various embodiments may extract and use the information about the depth and the prediction unit of the coding unit 1600 to decode the partition unit 1612. The video decoding apparatus 100 according to various embodiments may determine a depth, in which split information is 0, as the selected depth by using split information according to depths, and may use split information about the selected depth for decoding.

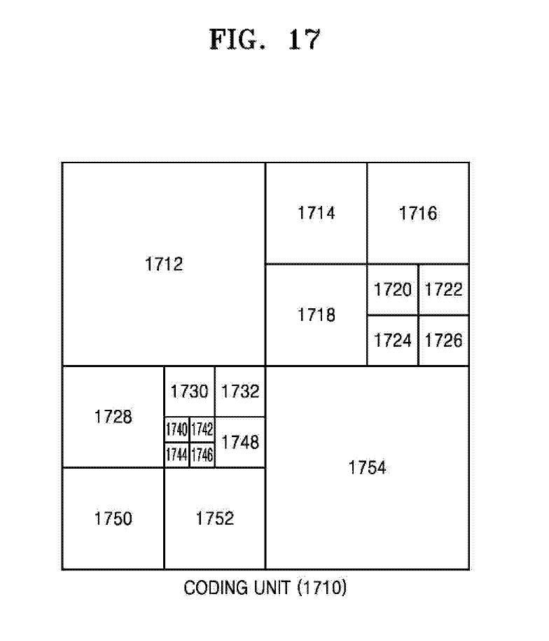

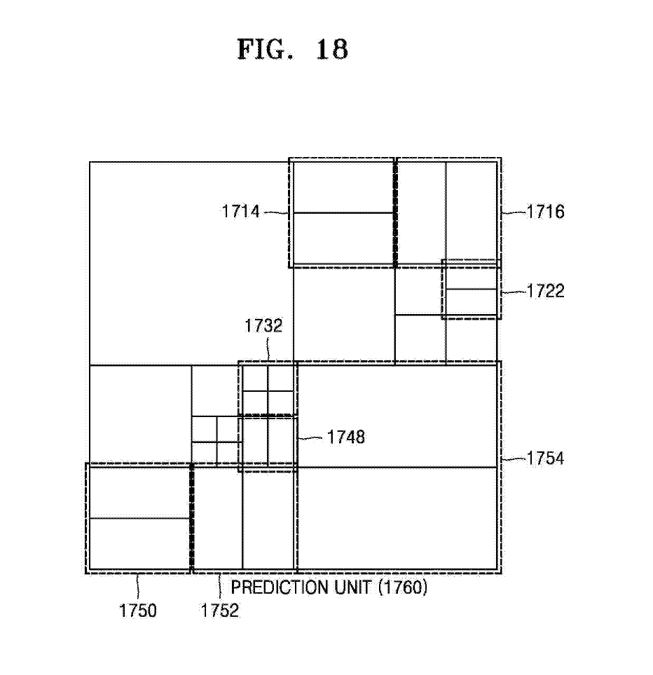

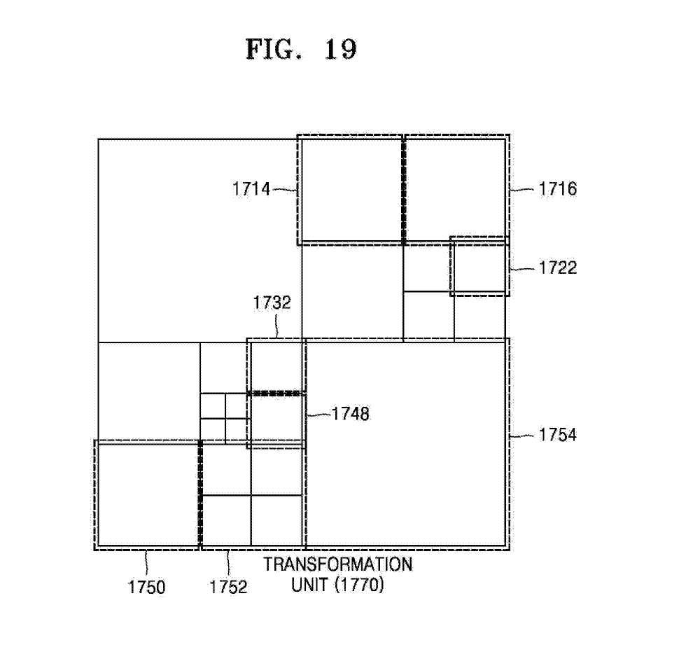

FIGS. 17, 18, and 19 are diagrams for describing a relationship between coding units, prediction units, and transformation units, according to an embodiment of the present disclosure.

The coding units 1710 are coding units having a tree structure, corresponding to depths determined by the video encoding apparatus 300, in a largest coding unit. The prediction units 1760 are partitions of prediction units of each of the coding units 1710, and the transformation units 1770 are transformation units of each of the coding units 1710.

When a depth of a largest coding unit is 0 in the coding units 1710, depths of coding units 1712 and 1754 are 1, depths of coding units 1714, 1716, 1718, 1728, 1750, and 1752 are 2, depths of coding units 1720, 1722, 1724, 1726, 1730, 1732, and 1748 are 3, and depths of coding units 1740, 1742, 1744, and 1746 are 4.

In the prediction units 1760, some encoding units 1714, 1716, 1722, 1732, 1748, 1750, 1752, and 1754 are obtained by splitting the coding units in the coding units 1710. That is, partition modes in the coding units 1714, 1722, 1750, and 1754 have a size of 2N×N, partition modes in the coding units 1716, 1748, and 1752 have a size of N×2N, and a partition mode of the coding unit 1732 has a size of N×N. Prediction units and partitions of the coding units 1710 according to depths are equal to or smaller than each coding unit.

Transformation or inverse transformation is performed on image data of the coding unit 1752 in the transformation units 1770 in a data unit that is smaller than the coding unit 1752. Also, the coding units 1714, 1716, 1722, 1732, 1748, 1750, 1752, and 1754 are different from those in the prediction units 1760 in terms of sizes and shapes. That is, the video encoding and decoding apparatuses 100 and 300 according to embodiments may perform intra prediction, motion estimation, motion compensation, transformation, and inverse transformation on an individual data unit in the same coding unit.

Accordingly, encoding is recursively performed on each of coding units having a hierarchical structure in each region of a largest coding unit to determine an optimum coding unit, and thus coding units having a recursive tree structure may be obtained. Encoding information may include split information about a coding unit, partition mode information, prediction mode information, and transformation unit information. Table 1 shows an example that may be set by the video encoding and decoding apparatuses 100 and 300 according to embodiments.

TABLE 1

| | | | | | Split |
|---|---|---|---|---|---|
| Split Information 0 | | | | | Information |
| (Encoding on Coding Unit having Size of 2N × 2N and Current Depth of d) | | | | | 1 |
| Prediction | Partition Type | | Size of Transformation Unit | | Repeatedly |
| Mode | | | | | Encode |
| Intra | Symmetrical | Asymmetrical | Split | Split | Coding |
| Inter | Partition | Partition | Information 0 | Information 1 | Units |
| Skip | Type | Type | of | of | having |
| (Only | | | Transformation | Transformation | Lower |
| 2N × 2N) | | | Unit | Unit | Depth of |
| | 2N × 2N | 2N × nU | 2N × 2N | N × N | d + 1 |
| | 2N × N | 2N × nD | | (Symmetrical | |
| | N × 2N | nL × 2N | | Partition Type) | |
| | N × N | nR × 2N | | N/2 × N/2 etc. | |
| | | etc. | | (Asymmetrical | |
| | | | | Partition Type) | |

The transmitter 320 of the video encoding apparatus 300 according to an embodiment may output the encoding information about the coding units having a tree structure, and the receiver 110 of the video decoding apparatus 100 according to an embodiment may extract, from a received bitstream, the encoding information about the coding units having a tree structure.

Split information indicates whether a current coding unit is split into coding units of a lower depth. If split information of a current depth d is 0, the current coding unit is no longer split into a lower coding unit, so that partition mode information, a prediction mode, and transformation unit size information may be defined for coding units having the current depth. If the current coding unit has to be further split according to the split information, encoding has to be independently performed on four split coding units of a lower depth.

A prediction mode may be one of an intra mode, an inter mode, and a skip mode. The intra mode and the inter mode may be defined in all partition modes, and the skip mode may be defined only in a partition mode having a size of 2N×2N.

The partition mode information may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1

The size of the transformation unit may be set to be two modes in the intra mode and two modes in the inter mode. That is, if split information of the transformation unit is 0, the size of the transformation unit may be 2N×2N, which is the size of the current coding unit. If split information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure may be allocated to at least one of a coding unit corresponding to a depth, a prediction unit, and a minimum unit. The coding unit corresponding to the depth may include at least one of a prediction unit and a minimum unit that contain the same encoding information.

Accordingly, it is determined whether adjacent data units are included in the same coding unit corresponding to the depth by comparing encoding information of the adjacent data units. Also, a coding unit having to a corresponding depth may be determined by using encoding information of a data unit, and thus a distribution of depths in a largest coding unit may be inferred therefrom.

Accordingly, if a current coding unit is predicted by referring to adjacent data units, encoding information of data units in deeper coding units adjacent to the current coding unit may be directly referred to and used.

As another example, if the current coding unit is prediction-encoded by referring to an adjacent data unit, the adjacent data unit may be referred in a manner that a data unit that is adjacent to the current coding unit and is in a deeper coding unit is searched by using encoding information of the deeper coding unit.

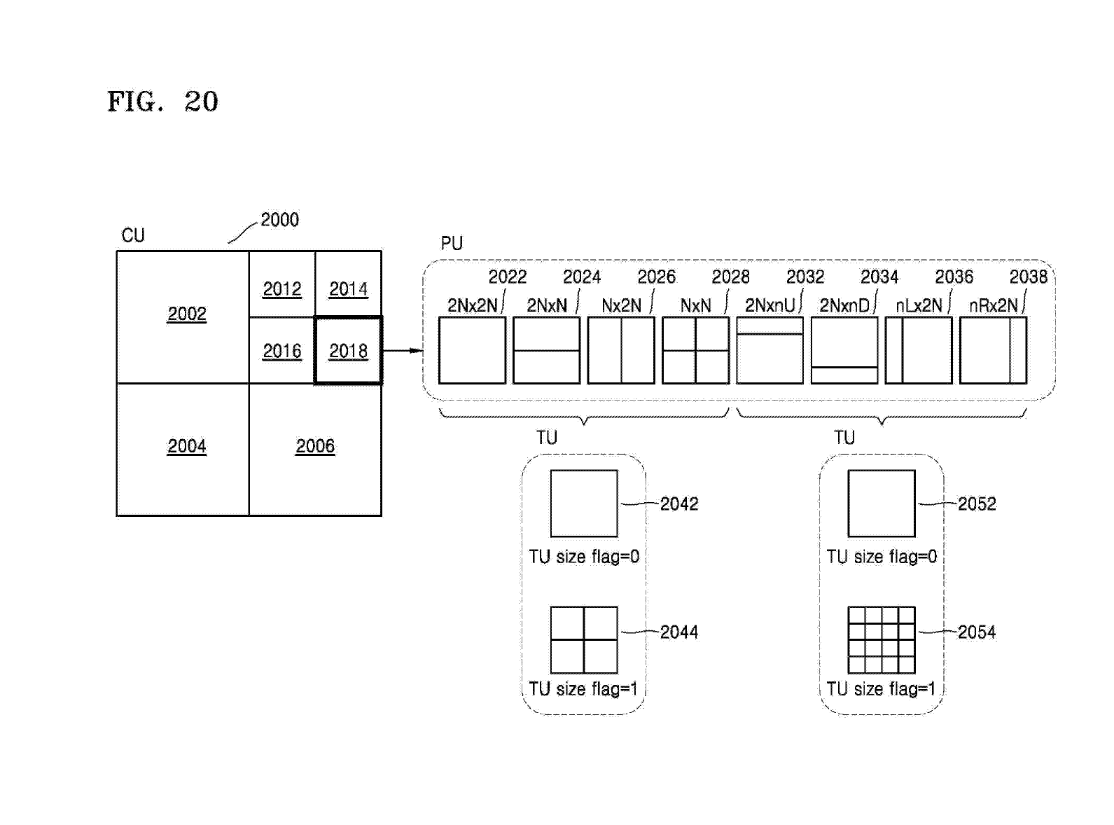

FIG. 20 is a diagram for describing a relationship between a coding unit, a prediction unit, and a transformation unit, according to encoding mode information of Table 1.

A largest coding unit 2000 includes coding units 2002, 2004, 2006, 2012, 2014, 2016, and 2018 of depths. Here, since the coding unit 2018 is a coding unit of a depth, split information may be set to 0. Information about a partition mode of the coding unit 2018 having a size of 2N×2N may be set to be one of a partition mode 2022 having a size of 2N×2N, a partition mode 2024 having a size of 2N×N, a partition mode 2026 having a size of N×2N, a partition mode 2028 having a size of N×N, a partition mode 2032 having a size of 2N×nU, a partition mode 2034 having a size of 2N×nD, a partition mode 2036 having a size of nL×2N, and a partition mode 2038 having a size of nR×2N.

Split information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 2022 having a size of 2N×2N, the partition mode 2024 having a size of 2N×N, the partition mode 2026 having a size of N×2N, or the partition mode 2028 having a size of N×N, a transformation unit 2042 having a size of 2N×2N may be set if the TU size flag of the transformation unit is 0, and a transformation unit 2044 having a size of N×N may be set if the TU size flag is 1.

When the partition mode is set to be asymmetrical, i.e., the partition mode 2032 having a size of 2N×nU, the partition mode 2034 having a size of 2N×nD, the partition mode 2036 having a size of nL×2N, or the partition mode 2038 having a size of nR×2N, a transformation unit 2052 having a size of 2N×2N may be set if the TU size flag is 0, and a transformation unit 2054 having a size of N/2×N/2 may be set if the TU size flag is 1.

Referring to FIG. 20, the TU size flag is a flag having a value or 0 or 1, but the TU size flag is not limited to 1 bit, and the transformation unit may be hierarchically split while the TU size flag increases from 0. The split information (TU size flag) of the transformation unit may be used as an example of a transformation index.

In this case, a size of a transformation unit that has been actually used may be expressed by using the TU size flag of the transformation unit according to an embodiment, together with a maximum size and minimum size of the transformation unit. The video encoding apparatus 300 according to an embodiment may encode maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 100 according to an embodiment may decode video by using the maximum transformation unit size information, the minimum transformation unit size information, and the maximum TU size flag.

For example, (a) if a size of a current coding unit is 64×64 and a maximum transformation unit size is 32×32, (a−1) then a size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max (MinTransformSize, RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an embodiment, the maximum transformation unit size RootTuSize may vary according to the mode of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize, PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize, PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the mode of a prediction mode in a partition unit is just an example and embodiments of the present disclosure are not limited thereto.

According to the video encoding method based on coding units having a tree structure as described with reference to FIGS. 5 through 20, image data of the spatial domain is encoded for each coding unit of a tree structure. According to the video decoding method based on coding units having a tree structure, decoding is performed for each largest coding unit to reconstruct image data of the spatial domain. Thus, a picture and a video that is a picture sequence may be reconstructed. The reconstructed video may be reproduced by a reproducing apparatus, may be stored in a storage medium, or may be transmitted through a network.

Also, offset parameters may be signaled with respect to each picture, each slice, each largest coding unit, each of coding units having a tree structure, each prediction unit of the coding units, or each transformation unit of the coding units. For example, sample values of reconstructed pixels of each largest coding unit may be adjusted by using offset values reconstructed based on received offset parameters, and thus a largest coding unit having a minimized error between an original block and the largest coding unit may be reconstructed.

The embodiments of the present disclosure may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

At least a portion of the element named “-er/or” used herein may be embedded as hardware. In addition, the hardware may include a processor. The processor may be a general purpose single- or multi-chip microprocessor (e.g., an ARM), a special purpose microprocessor (e.g., a digital signal processor (DSP)), a microcontroller, a programmable gate array, etc. The processor may be referred to as a central processing unit (CPU). In at least a portion of the element named with a suffix “-er/or”, a combination of processors (e.g., an ARM and DSP) may be used.

The hardware may also include a memory. The memory may be any electronic component capable of storing electronic information. The memory may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data and programs may be stored in the memory. The programs may be executable by the processor to implement the methods disclosed herein. Executing the programs may involve the use of the data stored in the memory. When the processor executes instructions, various portions of the instructions may be loaded onto the processor, and various pieces of data may be loaded onto the processor.

The exemplary embodiments of the present disclosure have been described. It can be understood that various modifications and changes can be made without departing from the scope of the present disclosure by one of skilled in the art to which the present disclosure pertains. Accordingly, the disclosed embodiments are to be considered as illustrative and not restrictive. The scope of the present disclosure is defined not by the detailed description of the present disclosure but by the appended claims, and all differences within the scope will be construed as being included in the present disclosure.

1. A video decoding method comprising:
splitting an encoded image into largest coding units;
parsing, from a bitstream of the image, split information indicating whether to split a coding unit by two;
parsing shape information indicating a split shape of a coding unit and including split direction information of a coding unit; and
determining a coding unit hierarchically split from the largest coding unit by using the split information and the shape information.

2. The video decoding method of claim 1, wherein the shape information includes split direction information indicating that the coding unit is split in one of a vertical direction and a horizontal direction.

3. The video decoding method of claim 2, wherein
the largest coding unit is hierarchically split into a coding unit having a depth including at least one of a current depth and a lower depth according to the split information,
when direction information of the coding unit having the current depth indicates a vertical split, direction information of the coding unit having the lower depth indicates a horizontal split, and
when the direction information of the coding unit having the current depth indicates a horizontal split, the direction information of the coding unit having the lower depth indicates a vertical split.

4. The video decoding method of claim 1, wherein the shape information includes split position information indicating a split position corresponding to a position with respect to one of a height and a width of the coding unit.

5. The video decoding method of claim 4, further comprising:
determining a number by dividing one of the height and the width of the coding unit by a certain length; and
determining a split position with respect to one of the height and the width of the coding unit, based on the number and the split position information.

6. The video decoding method of claim 4, wherein the split position information indicates that the coding unit is split by two at one of positions corresponding to ¼, ⅓, ⅔, and ¾ of one of the height and the width of the coding unit.

7. The video decoding method of claim 1, further comprising determining at least one prediction unit split from the coding unit by using information about a partition type parsed from the bitstream.

8. The video decoding method of claim 1, further comprising determining at least one transformation unit split from the coding unit by using information about a split shape of the transformation unit parsed from the bitstream.

9. The video decoding method of claim 8, wherein the transformation unit has a square shape, and
a length of one side of the transformation unit is a greatest common divisor of a length of a height of the coding unit and a length of a width of the coding unit.

10. The video decoding method of claim 8, wherein the coding unit is hierarchically split into a transformation unit having a depth including at least one of a current depth and a lower depth, based on information about a split shape of the transformation unit.

11. The video decoding method of claim 8, further comprising:
parsing encoding information indicating a presence or absence of a transformation coefficient for the coding unit; and
when the encoding information indicates the presence of the transformation coefficient, parsing sub-encoding information indicating a presence or absence of transformation coefficient for each transformation unit included in the coding unit.

12. The video decoding method of claim 1, wherein the largest coding units have square shapes having a same size.

13. A video decoding apparatus comprising:
a receiver configured to parse, from a bitstream of an image, split information of a coding unit indicating whether to split a coding unit by two, and parse shape information of the coding unit indicating a split shape of the coding unit and including split direction information of the coding unit; and
a decoder configured to split an encoded image into largest coding units and determine a coding unit hierarchically split from the largest coding unit by using the split information and the shape information.

14. A non-transitory computer-readable recording medium having recorded thereon a program for performing the video decoding method of claim 1.

15. A video encoding method comprising:
splitting an image into largest coding units;
hierarchically splitting a coding unit from the largest coding unit;
determining split information indicating whether to split the largest coding unit into two coding units and shape information indicating a split shape of the coding unit;
encoding the split information and the shape information; and
transmitting a bitstream including the encoded split information and the encoded shape information.

16. (canceled)
